(19) United States
(12) Patent Application Publication
(10) Pub. No.: US 2023/0130160 A1
(43) Pub. Date: Apr. 27, 2023

(54) SYSTEM FOR DETECTING AN OBSTACLE FOR A MOTOR VEHICLE

(71) Applicant: TOYOTA MOTOR EUROPE, Brussels (BE)

(72) Inventor: Dennis LAVIGNE, Brussels (BE)

(21) Appl. No.: 17/917,235

(22) PCT Filed: Apr. 6, 2020
(86) PCT No.: PCT/EP2020/059766

§ 371 Date: Oct. 5, 2022

(51) Int. Cl. E05F 15/40; E05F 15/73

(52) U.S. Cl. CPC E05F 15/40; E05F 15/73; E05F 2015/767; E05Y 2400/54; E05Y 2400/612; E05Y 2900/546

(57) ABSTRACT

A system including a sensor supported by a motor vehicle, the sensor configured to send a first signal corresponding to an obstacle within a proximity of a door, an electronic control unit configured to receive the first signal from the sensor, the electronic control unit configured to send a second signal based upon the first signal, the second signal being capable of controlling operation of the door, an energy source configured to power the sensor and the electronic control unit independent of whether the motor vehicle is in an on condition or an off condition, and wherein the sensor sends the first signal and the electronic control unit sends the second signal to control operation of the door when the sensor detects an obstacle within proximity of the door.

### RELATED APPLICATIONS

The present application is a National Phase of International Application Number PCT/EP2020/059766, filed Apr. 6, 2020.

### FIELD

The present disclosure relates generally to the field of motor vehicles. More specifically, the present disclosure relates to a system for detecting an obstacle within proximity of a door of a motor vehicle.

### BACKGROUND

A power back door feature of a motor vehicle provides for convenience and ease of use. With a power back door feature, a user no longer has to expend energy to open and close the back door or, for some motor vehicles, even touch the back door in order to open and close the back door. However, many currently available power back door features do not account for obstacles which may be present in proximity of the back door. For many currently available power back door features, if the back door touches an obstacle, the power back door feature will sense a change in speed of the back door (using the speed of the back door under normal operation as a reference) and subsequently stop movement of the back door. However, at the point the back door contacts the obstacle so that the power back door feature can sense the change in speed of the back door, a person may have already been struck and injured by the back door or the back door may have already been damaged due to striking the obstacle.

It is desirable to provide an improved system for a power back door feature of a motor vehicle configured to detect an obstacle within proximity of a back door of a motor vehicle in order to prevent injury to a person and damage to the back door, when opening or closing the back door of the motor vehicle.

### SUMMARY

According to aspects of the present disclosure a system for detecting an obstacle within proximity of a door of a motor vehicle includes one or more sensor supported by a motor vehicle, the one or more sensor being configured to send a first signal corresponding to an obstacle within a proximity of the door, an electronic control unit (hereafter, “ECU”) being configured to receive the first signal from the one or more sensor, the ECU being configured to send a second signal based upon the first signal from the one or more sensor, the second signal being capable of controlling operation of the door, an energy source being configured to power the one or more sensor and the ECU independent of whether the motor vehicle is in an on condition or an off condition, and wherein the one or more sensor sends the first signal and the ECU sends the second signal to control operation of the door when the one or more sensor detects an obstacle within proximity of the door.

According to aspects of the disclosure, the one or more sensor also functions as a parking sensor to aid a user in parking a motor vehicle.

According to aspects of the disclosure, the one or more sensor is supported within a door of a motor vehicle.

According to aspects of the disclosure, the door is a power back door configured to such that opening and closing of the power back door is triggered by a user.

According to aspects of the disclosure, the energy source is also configured to power the power back door.

According to aspects of the disclosure, the one or more sensor is configured to detect the obstacle when the door is in a resting condition or when the door is in the process of opening or closing.

According to aspects of the disclosure, the one or more sensor includes a plurality of sensors included within the door.

According to aspects of the disclosure, the one or more sensor includes a plurality of sensors included within a bumper of a motor vehicle.

According to aspects of the disclosure, the ECU sends the second signal to stop opening or closing of the door based upon receipt of the first signal.

According to aspects of the disclosure, the one or more sensor includes a camera.

According to aspects of the disclosure, the energy source is a battery.

In the manner described and according to aspects illustrated herein, the system is configured to detect an obstacle within proximity of a door of a motor vehicle in order to prevent injury to a person and damage to the door, when opening or closing the door of the motor vehicle.

### BRIEF DESCRIPTION OF THE DRAWINGS

Aspects of an embodiment will be described in reference to the drawings, where like numerals reflect like elements:

FIG. 1 is a perspective view of a system for detecting an obstacle within a proximity of a door of a motor vehicle (hereafter, “the system”), showing a first sensor, according to aspects of the disclosure.

FIG. 2 is a perspective view of the system of FIG. 1, showing a second sensor.

FIG. 3 is a perspective view of the system of FIG. 1, showing the first sensor and the second sensor.

FIG. 4A is a perspective view of a power back door of a motor vehicle according to aspects of the disclosure, showing activation of the power back door via a handle;

FIG. 4B is a perspective view of a remote control for a keyless entry system of a motor vehicle according to aspects of the disclosure, showing activation of a power back door of the motor vehicle via the remote control;

FIG. 4C is a perspective view of a console of a motor vehicle according to aspects of the disclosure, showing activation of a power back door of the motor vehicle via the console;

FIG. 4D is a perspective view of a kick sensor of a motor vehicle according to aspects of the disclosure, showing activation of a power back door of the motor vehicle via the kick sensor; and

FIG. 5 is a schematic view of the system according to FIG. 3.

### DETAILED DESCRIPTION

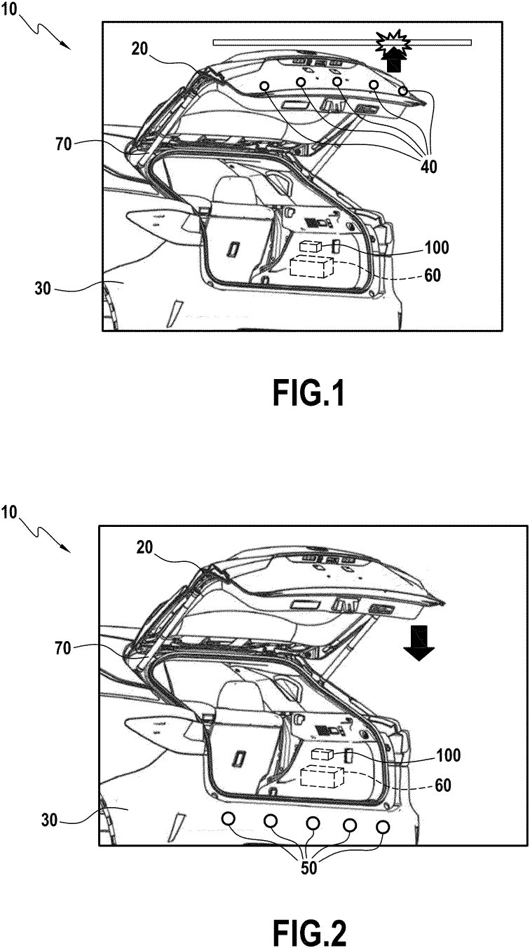

An embodiment of the system according to aspects of the disclosure will now be described with reference to FIGS. 1 4A 4B 4C 4D 5, wherein like numerals represent like parts, and will generally be referred to by the reference numeral 10. Although the system 10 is described with reference to specific examples, it should be understood that modifications and changes may be made to these examples without going beyond the general scope as defined by the claims. In particular, individual characteristics of the various embodiments shown and/or mentioned herein may be combined in additional embodiments. Consequently, the description and the drawings should be considered in a sense that is illustrative rather than restrictive. The Figures, which are not necessarily to scale, depict illustrative aspects and are not intended to limit the scope of the disclosure. The illustrative aspects depicted are intended only as exemplary.

The term “exemplary” is used in the sense of “example,” rather than “ideal.” While aspects of the disclosure are amenable to various modifications and alternative forms, specifics thereof have been shown by way of example in the drawings and will be described in detail. It should be understood, however, that the intention is not to limit aspects of the disclosure to the particular embodiment(s) described. On the contrary, the intention of this disclosure is to cover all modifications, equivalents, and alternatives falling within the scope of the disclosure.

Various materials, methods of construction and methods of fastening will be discussed in the context of the disclosed embodiment(s). Those skilled in the art will recognize known substitutes for the materials, construction methods, and fastening methods, all of which are contemplated as compatible with the disclosed embodiment(s) and are intended to be encompassed by the appended claims.

As used in this disclosure and the appended claims, the singular forms “a,” “an,” and “the” include plural referents unless the content clearly dictates otherwise. As used in this disclosure and the appended claims, the term “or” is generally employed in its sense including “and/or” unless the content clearly dictates otherwise.

Throughout the description, including the claims, the terms “comprising a,” “including a,” and “having a” should be understood as being synonymous with “comprising one or more,” “including one or more,” and “having one or more” unless otherwise stated. In addition, any range set forth in the description, including the claims should be understood as including its end value(s) unless otherwise stated. Specific values for described elements should be understood to be within accepted manufacturing or industry tolerances known to one of skill in the art, and any use of the terms “substantially,” “approximately,” and “generally” should be understood to mean falling within such accepted tolerances.

When an element or feature is referred to herein as being “on,” “engaged to,” “connected to,” or “coupled to” another element or feature, it may be directly on, engaged, connected, or coupled to the other element or feature, or intervening elements or features may be present. In contrast, when an element or feature is referred to as being “directly on,” “directly engaged to,” “directly connected to,” or “directly coupled to” another element or feature, there may be no intervening elements or features present. Other words used to describe the relationship between elements or features should be interpreted in a like fashion (e.g., “between” versus “directly between,” “adjacent” versus “directly adjacent,” etc.).

Spatially relative terms, such as “top,” “bottom,” “middle,” “inner,” “outer,” “beneath,” “below,” “lower,” “above,” “upper,” and the like, may be used herein for ease of description to describe one element or feature’s relationship to another element(s) or feature(s) as illustrated in the drawings. Spatially relative terms may be intended to encompass different orientations of a device in use or operation in addition to the orientation depicted in the drawings. For example, if the device in the drawings is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although the terms “first,” “second,” etc. may be used herein to describe various elements, components, regions, layers, sections, and/or parameters, these elements, components, regions, layers, sections, and/or parameters should not be limited by these terms. These terms are only used to distinguish one element, component, region, layer, or section from another region, layer, or section. Thus, a first element, component, region, layer, or section discussed herein could be termed a second element, component, region, layer, or section without departing from the teachings of the present disclosure.

As shown in FIGS. 1-3, the system 10 includes sensors 40, 50 supported by a motor vehicle, which are configured to detect an obstacle within proximity the motor vehicle. Particularly, the system 10 is configured for use on a door 20 of a motor vehicle, preferably a back door 20 of a motor vehicle, and most preferably a power back door 20 of a motor vehicle. The term “power back door” as used herein should be understood to mean a door capable of opening and closing upon being triggered by a user, without substantial application of force on the door by a user. The system 10 is contemplated to work in combination with and/or in addition to existing features within the motor vehicle. As such, the system 10 is configured to work in combination with and/or in addition to features of the power back door 20. The features of a power back door 20 which the system is configured to work in combination with and/or in addition to include an electronic control unit (hereafter, “ECU”) 60 of the power back door 20, an opening and closing mechanism 70 of the power back door 20, and an energy source 100 of the power back door 20. In the disclosed embodiment, the opening and closing mechanism 70 may be any mechanism capable of opening and closing a power back door 20 such as an electric motor, a pneumatic cylinder, or a hydraulic cylinder. In the disclosed embodiment, the energy source 100 may be a battery which provides power to the power back door 20 independent of whether the motor vehicle is in an on condition (engine of the motor vehicle is running) or an off condition (engine of the motor vehicle is not running). Additionally, the system 10 is configured to work in combination with and/or in addition to a system for detecting a presence of obstacles in proximity to the motor vehicle to aid a user in navigating a parking operation. Additionally or alternatively, the system 10 may be configured to function independently of any existing features within the motor vehicle.

In the disclosed embodiment, it is contemplated that the sensors 40, 50 are proximity sensors such as ultrasonic proximity sensors, electromagnetic parking sensors, optical sensors, and/or any instrument capable of detecting presence of obstacles within proximity of a power back door 20 of a motor vehicle. It is contemplated that the term “proximity” as used herein may be understood to mean a distance within 10 meters of the sensors 40, 50 described. The sensors 40, 50 described herein, in combination with existing features of the motor vehicle or independent of existing features of the motor vehicle, are configured to detect an obstacle within proximity of the power back door 20 of the motor vehicle to prevent damage to the power back door 20 and injury to a person when opening or closing the power back door 20 of the motor vehicle.

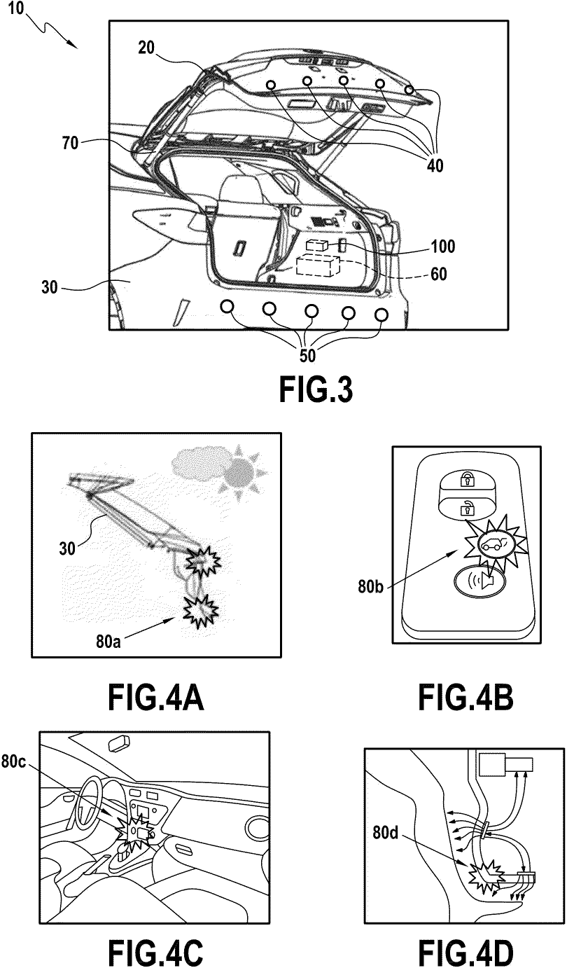

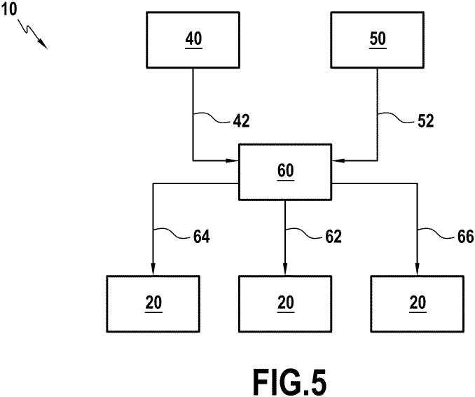

As shown in FIGS. 1 and 3, the system 10 includes one or more first sensor 40. In the disclosed embodiment, the system 10 includes a plurality of first sensors 40. The first sensors 40 are configured to be supported by and/or included within the power back door 20 of the motor vehicle. The first sensors 40 may function as parking sensors as well as to detect an obstacle with proximity of the power back door 20 of the motor vehicle when opening or closing the power back door 20 of the motor vehicle. To this end, the first sensors 40 are powered by the energy source 100, which provides power to the first sensors 40 regardless of whether the motor vehicle is in the on condition or the off condition. Therefore, the first sensors 40 are configured to function when the motor vehicle is in the on condition and when the motor vehicle is in the off condition. Additionally, the first sensors 40 may function when the power back door 20 of the motor vehicle is in a resting state (fully-closed or fully-open) and when the power back door 20 is in the process of opening or closing. As shown in FIG. 5, the first sensors 40 are configured to send a first signal 42 to an ECU 60 of the motor vehicle. In the disclosed embodiment, the ECU 60 is powered by the energy source 100, which provides power to the ECU 60, and thus the power back door 20, independent of whether the motor vehicle is in the on condition or the off condition. The first signal 42 of the first sensors 40 corresponds to a positive detection of an obstacle within proximity of the power back door 20 of the motor vehicle. The first signal 42 is sent to the ECU 60 of the motor vehicle to cause the power back door 20 to not move and/or to stop moving to protect the power back door 20 from damage and/or to protect an obstacle, which may be a person, positioned within proximity of the motor vehicle.

As shown in FIGS. 2 and 3, additionally or alternatively, the system 10 may include one or more second sensor 50. In the disclosed embodiment, the system 10 includes a plurality of second sensors 50. The second sensors 50 are configured to be supported by and/or included within a bumper 30 of the motor vehicle. The second sensors 50 may function as parking sensors as well as to detect an obstacle with proximity of the power back door 20 of the motor vehicle when opening or closing the power back door 20 of the motor vehicle. To this end, the second sensors 40 are powered by the energy source 100, which provides power to the second sensors 50 regardless of whether the motor vehicle is in the on condition or the off condition. Therefore, the second sensors 50 are configured to function when the motor vehicle is in the on condition and when the motor vehicle is in the off condition. Additionally, the second sensors 50 may function when the power back door 20 of the motor vehicle is in the resting state (fully-closed or fully-open) and when the power back door 20 is in the process of opening or closing. As shown in FIG. 5, the second sensors 50 are configured to send a first signal 52 to the ECU 60 of the motor vehicle. The first signal 52 of the second sensors 50 corresponds to a positive detection of an obstacle within proximity of the bumper 30 of the motor vehicle, and thus the power back door 20 of the motor vehicle. The first signal 52 is sent to the ECU 60 of the motor vehicle to cause the power back door 20 to not move and/or to stop moving to protect the power back door 20 from damage and/or to protect an obstacle, which may be a person, positioned within proximity of the motor vehicle.

As shown in FIG. 3, it is contemplated that the first sensors 40 and/or the second sensors 50 may be supported by and/or incorporated into a motor vehicle as a part of the system 10. The system 10 may include the first sensors 40 and the second sensors 50 in combination (see FIG. 3), the first sensors 40 without the second sensors 50 (see FIG. 1), or the second sensors 50 without the first sensors 40 (see FIG. 2). In any configuration, the first sensors 40 and/or the second sensors 50 send the first signal 42, 52 to the ECU 60 of the motor vehicle based upon positive detection of an obstacle within proximity of the power back door 20 of the motor vehicle.

As shown in FIG. 5, the system 10 includes an ECU 60 configured to receive the first signal 42, 52 from the first sensors 40 and/or the second sensors 50. The ECU 60 may be configured to control the power back door 20. As such, the ECU 60 is configured to control automatic opening and closing of the power back door 20 of a motor vehicle by sending an open door signal 64 and a close door signal 66 to the electric motor 70 of the power back door 20. The ECU 60, and thus the power back door 20, is powered by the energy source 100, which provides power to the ECU regardless of whether the motor vehicle is in the on condition or the off condition. Therefore, the ECU 60 is capable of functioning when the motor vehicle is in the on condition and when the motor vehicle is in the off condition. The ECU 60 is capable of functioning when the power back door 20 of the motor vehicle is in the resting state (fully-closed or fully-open) and when the power back door 20 is in the process of opening or closing. The ECU 60 may also be configured to function along with the first sensors 40 and/or the second sensors 50 to function as a parking aid, as well as to detect an obstacle with proximity of the power back door 20 of the motor vehicle when opening or closing the power back door 20 of the motor vehicle. As mentioned above, the ECU 60 is configured to receive the first signal 42, 52 from the first sensors 40 and/or the second sensors 50. The ECU is configured to send a second signal 62 based upon the first signal 42, 52 from the first sensors 40 and/or the second sensors 50. The second signal 62 is capable of controlling operation of the power back door 20 of the motor vehicle. It is contemplated that the second signal 62 is sent to the opening and closing mechanism 70 of the power back door 20 of the motor vehicle to stop movement of the power back door 20 of the motor vehicle. The second signal 62 stops movement of the power back door 20 of the motor vehicle to protect the power back door 20 from damage and/or to protect the obstacle, which may be a person, positioned within proximity of the motor vehicle.

As illustrated by FIGS. 4A-4D, the power back door 20 may be activated to open or close via a handle 80a of the power back door 20 (see FIG. 4A), a remote control 80b (see FIG. 4B), a console 80c of the motor vehicle (see FIG. 8C), and/or a kick sensor 80d of the power back door 20 (see FIG. 8D). Additionally, it is contemplated that the remote control 80b may be configured to communicate with the first sensors 40 and/or the second sensors 50 to so that the presence of a user is detected within proximity of the power back door 20.

Although the present disclosure herein has been described with reference to particular embodiments, it is to be understood that these embodiments are merely illustrative of the principles and applications of the present disclosure.

It is intended that the specification and examples be considered as exemplary only, with a true scope of the disclosure being indicated by the following claims.

Additionally, all of the disclosed features of an apparatus may be transposed, alone or in combination, to a method and vice versa.

1. A system for detecting an obstacle within proximity of a door of a motor vehicle, the system comprising:
one or more sensor supported by a motor vehicle, the one or more sensor configured to send a first signal corresponding to an obstacle within a proximity of the door;
an electronic control unit configured to receive the first signal from the one or more sensor, the electronic control unit configured to send a second signal based upon the first signal from the one or more sensor, the second signal being capable of controlling operation of the door;
an energy source configured to power the one or more sensor and the electronic control unit independent of whether the motor vehicle is in an on condition or an off condition; and
wherein the one or more sensor sends the first signal and the electronic control unit sends the second signal to control operation of the door when the one or more sensor detects an obstacle within proximity of the door.

2. The system of claim 1, wherein the one or more sensor also functions as a parking sensor to aid a user in parking a motor vehicle.

3. The system of claim 1, wherein the one or more sensor is supported within a door of a motor vehicle.

4. The system of claim 3, wherein the door is a power back door configured such that opening and closing of the power back door is triggered by a user.

5. The system of claim 4, wherein the energy source is also configured to power the power back door.

6. The system of claim 2, wherein the one or more sensor is configured to detect the obstacle when the door is in a resting condition or when the door is in the process of opening or closing.

7. The system of claim 2, wherein the one or more sensor comprises a plurality of sensors included within the door.

8. The system of claim 1, wherein the one or more sensor comprises a plurality of sensors included within a bumper of a motor vehicle.

9. The system of claim 1, wherein the electronic control unit sends the second signal to stop opening or closing of the door based upon receipt of the first signal.

10. The system of claim 1, wherein the one or more sensor includes a camera.

11. The system of claim 1, wherein the energy source is a battery.
